(19) United States
(12) Patent Application Publication
(10) Pub. No.: US 2004/0032656 A1
(43) Pub. Date: Feb. 19, 2004

(54) Polarization conversion system and method of calibrating same

(76) Inventor: Valter Drazic, Betton (FR)

Correspondence Address: THOMSON multimedia Licensing Inc., Patent Operations, Two Independence Way, Post Office Box 5312, Princeton, NJ, 08540-5312, US

(21) Appl. No.: 10/219,394

(22) Filed: Aug. 15, 2002

(51) Int. Cl. F21V 9/14; G02B 5/30; G02B 27/28; G02B 6/00; F21V 7/04; G09F 13/00

(52) U.S. Cl. 359/487; 359/485; 359/494; 362/19; 362/551

(57) ABSTRACT

A polarization conversion system (100) and a method of calibrating the same includes a polarizing beam splitter (PBS) array(110) and at least a first lens (115) and a second lens (120) cascaded for receiving unpolarized light generated from a light source (135). The position of the first or second lens can be adjustable for calibrating the focus of the unpolarized light onto the PBS array. Alternatively, both lenses can be adjustable. The polarization conversion system can be incorporated into an LCD display which includes an imager (155). A third lens (125) and a fourth lens (130) can be cascaded and positioned for receiving polarized light from the polarizing beam splitter array and focusing the polarized light onto an imager. The system can be calibrated by adjusting the position of at least one lens to focus unpolarized light onto the PBS array, thereby reducing reflection of the unpolarized light from the polarizing beam splitter array.

### BACKGROUND OF THE INVENTION

1. Technical Field

The present invention relates to the field of projection displays, and more particularly to polarization recovery systems for projection displays.

2. Description of the Related Art

Liquid crystal projection displays (LCDs), including those that are liquid crystal on silicon (LCOS), typically use light polarization conversion systems to provide a particular light polarization for illumination of their imagers. One such polarization conversion system places a light pipe and a polarizing beam splitter (PBS) array in the illumination path between a lamp and the imager. Further, light focusing lenses are commonly placed between the light pipe and the PBS array.

The efficiency of light throughput in a polarization conversion system can be adversely affected by misalignment of the system's optical components; for example an improper distance between the lamp reflector and the light pipe, or the PBS array lying out of focus with respect the light pipe. These misalignments cause light that should be focused on particular sections of the PBS array to be spilled over onto neighboring sections of the array, which leaves the light unusable for its' intended purpose. For example, if the neighboring sections are aluminized, the light that is spilled over is reflected away from the PBS array. If the PBS array is not aluminized, the light that spilled over is transmitted with a wrong polarization and is absorbed elsewhere in the system. Hence, a typical polarization conversion system commonly wastes much of the light energy intended for illumination of the imager. This light energy not used for illumination is typically dissipated as heat, which can lead to overheating of the polarizer, especially when the display is small.

### SUMMARY OF THE INVENTION

The present invention relates to a polarization conversion system. The polarization conversion system includes a polarizing beam splitter array and at least a first lens and a second lens cascaded for receiving unpolarized light generated from a light source. The light source can be a lamp including an element and a reflector. The first and second lenses focus the unpolarized light onto the polarizing beam splitter array. The position of the first or second lens can be adjustable for calibrating the focus of the unpolarized light onto the polarizing beam splitter array. Alternatively, both lenses can be adjustable.

The polarization conversion system can further include a light pipe positioned between the light source and the first lens. The light pipe can have an input for receiving the unpolarized light from the light source and an output for outputting the unpolarized light towards the first lens.

The polarization conversion system can be incorporated into an LCD display and can include an imager that receives polarized light from the polarizing beam splitter. A third lens and a fourth lens can be cascaded and positioned for receiving polarized light from the polarizing beam splitter array and focusing the polarized light onto the imager. The position of at least one of the third and fourth lenses also can be adjustable to calibrate the size of the polarized light beam to match the imager.

The present invention also relates to a method of calibrating a polarization conversion system that includes a light pipe, a polarizing beam splitter array, and at least two lenses located between the light pipe and the polarizing beam splitter array. The method includes adjusting the position of at least one of the lenses to focus unpolarized light onto the polarizing beam splitter array, thereby optimizing the throughput for the usable polarization state. The method also can include the step of adjusting the position at least one of a third lens and a fourth lens to adjust the size of a beam of polarized light onto an imager, the polarized light being received from the polarizing beam splitter array.

### BRIEF DESCRIPTION OF THE DRAWINGS

FIG. 1 is a diagram of a polarization conversion system for use in a liquid crystal display in accordance with the present invention.

FIG. 2 is a perspective view of an adjustable lens fitted barrel in accordance with the present invention.

FIG. 3A is a front view of light beams incident on a polarizing beam splitter array in a polarization conversion system in accordance with the present invention.

FIG. 3B is a detail view of a single light beam incident on the polarizing beam splitter array of FIG. 3A in accordance with the present invention.

FIG. 3C is a detail view of a single light beam incident on a polarizing beam splitter array in an uncalibrated polarization conversion system.

FIG. 3D shows an amount of light spilling onto a wrong section of a polarizing beam splitter array in an uncalibrated polarization conversion system.

FIG. 3E shows an amount of light refracted into the polarizing beam splitter array in an uncalibrated polarization conversion system.

### DETAILED DESCRIPTION OF THE PREFERRED EMBODIMENTS

The present invention is a polarization conversion system for use in a liquid crystal display (LCD) projection system, including those displays that are liquid crystal on silicon (LCOS). The polarization conversion system includes an adjustable lens that can be calibrated to accurately focus unpolarized light onto particular regions of a polarizing beam splitter (PBS) array so that a maximum amount of light having the proper polarization is refracted through the PBS array. Accordingly, the amount of light used for illumination of an imager is maximized and the amount of light energy otherwise dissipated within the projector is reduced.

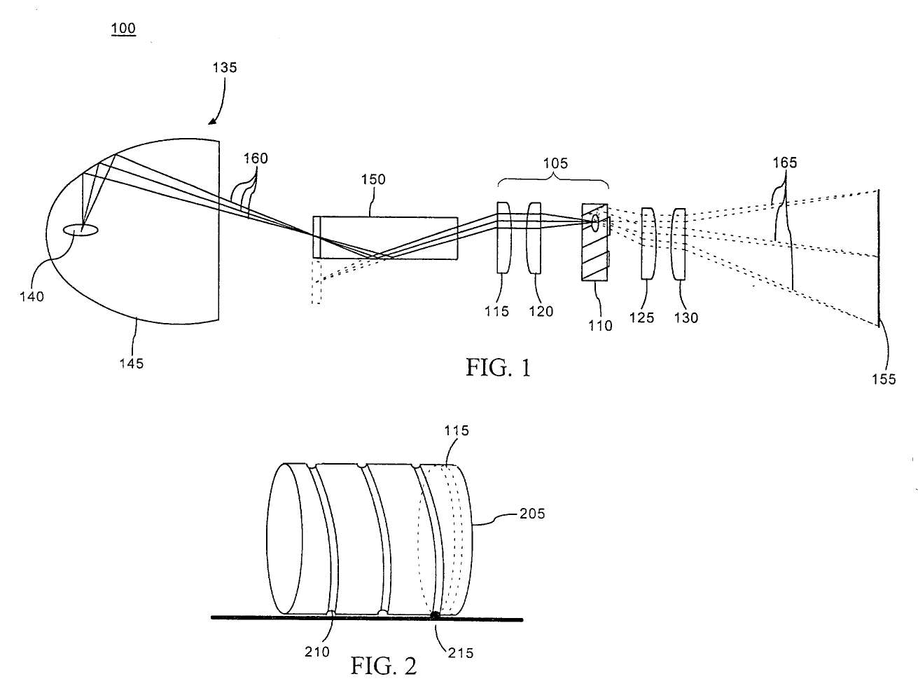

Referring to FIG. 1, a light system 100 for use in a LCD projection system is shown. The light system includes a polarization conversion system 105, a light source 135, a light pipe 150, and an imager 155. The light source 135 can be a lamp including reflector 145 and an element 140. In operation, unpolarized light is generated by the light source 135 and delivered to the polarization conversion system 105 via light pipe 150. The polarization conversion system 105 polarizes the light and projects the polarized light onto an imager 155 via third lense 125 and fourth lens 130. In an alternate embodiment, a plurality of light sources and light pipes can be used to increase imager illumination in a high performance LCD projector.

The polarization conversion system 105 includes a PBS array 110, a first lens 115, and a second lens 120. The first and second lenses 115 and 120 are positioned to receive unpolarized light 160 from the light pipe 150 and focus the unpolarized light 160 onto the PBS array 110. Notably, additional lenses can be positioned between the light pipe 150 and the PBS array 110 to supplement the focusing operation of the first and second lenses 115 and 120. The third and fourth lenses can be positioned between the PBS array 110 and the imager 155 to focus light 165 polarized by the PBS array 110 onto the imager 155. Again, additional lenses can be added between the PBS array 110 and the imager 155 to supplement the focusing operation of the third and fourth lenses 125 and 130.

The light pipe 150 can be a flexible and semi-transparent tube that reflects and refracts light internally within its' body to conduct the light from one location to another location. Hence, the light source 135 can be located in any desired position on a product and need not necessarily be located proximate to the imager 155. Reflection, refraction, and wavelength effects are taken into consideration when implementing a light pipe, as is known to one skilled in art of LCD projection systems.

The position of the first lens 115 can be adjusted along the optical axis to focus unpolarized light 160 onto the PBS array 110. For example, referring to FIG. 2, lens 115 can be mounted in an adjustable barrel 205 having an external spiral groove 210 around its circumference. The barrel 205 can be rotatable about its' axis, which is parallel to the optical axis, and moveable along the axis. When installed into a polarization conversion system 105, the barrel 205 can be positioned against a fixed protrusion 215 wherein the fixed protrusion 215 fits into the screw groove 210. Thus, rotation of the barrel 205 can cause the barrel 205 to move forward and backward along the optical axis causing an adjustment in the position of the lens 115. In one arrangement, the protrusion 215 can be a screw that can be tightened against the barrel 205 to fix the position of the barrel 205, and hence the first lens 115. Alternatively, lens 115 can be fixed and lens 120 can be moved relative to lens 115 using a moving means, such as a barrel similar to barrel 205. Optionally, both lenses 115 and 120 can be configured to move relative to each other within contemplation of the present invention.

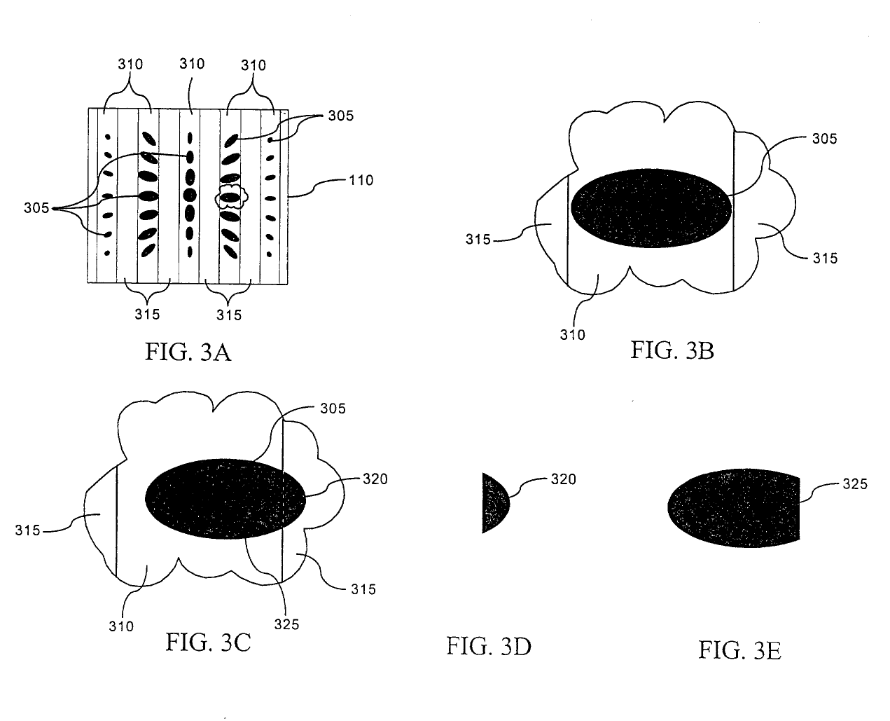

A front view of the PBS array 110 is shown in FIG. 3A. Multiple images 305 of unpolarized light 160 are incident upon the PBS array 110 due to reflections in the light pipe 150. The position of the first lens 115 can be adjusted so that the images 305 are each focused onto a PBS array element 310. Referring to FIG. 3B, which is a detail view of a single image 305 of FIG. 3A, maximum polarized light throughput is achieved when each image 305 is centered in, and focused upon, a single element 310. If the image 305 is not centered or focused upon a single element 310, as shown in FIG. 3C, an amount of light 320, shown in FIG. 3D, is spilled onto a neighboring element 315.

In the case that the neighboring element 315 has a reflective coating, such as aluminum, the amount of light 320 that is spilled onto the neighboring element 315 is reflected from the PBS array 110. In the case that the neighboring element 315 does not have a reflective coating, the light 320 spilled onto the neighboring element 315 is transmitted through the PBS array, but with the wrong polarization. In any case, the light spilled onto the neighboring element 315 becomes virtually useless for the intended purpose of properly illuminating the imager 155. The amount of light 325 that is incident on the element 310, shown in FIG. 3E, is useful light that is processed by the PBS array 110 and forwarded to the imager with the correct polarization.

Importantly, this ability to adjust the lenses 1 15 and/or 120 provides a significant advantage in LCD projector manufacturing. First, it should be noted that manufacturing tolerances commonly vary in LCD production. The adjustability of the position of the lenses 115 and/or 120 in polarization conversion systems 105 can enable each polarization conversion system to be calibrated to focus the unpolarized light 160 onto the PBS array 110, thereby compensating for manufacturing tolerances and maximizing light efficiency in each LCD projector produced.

Second, light energy that is not used for illuminating an imager is often dissipated in the form of heat. This heat dissipation can cause overheating of LCD components, especially in small LCD projectors. The ability to calibrate the focus of light in the LCD projectors to maximize light efficiency can reduce heating effects.

It should be understood that the examples and embodiments described herein are for illustrative purposes only and that various modifications or changes in light thereof can be suggested by persons skilled in the art and are to be included within the spirit and purview of this application. The invention can take many other specific forms without departing from the spirit or essential attributes thereof for an indication of the scope of the invention.

We claim:

1. A polarization conversion system comprising:
a polarizing beam splitter array; and
at least a first lens and a second lens cascaded for receiving unpolarized light generated from a light source and focusing said unpolarized light onto said polarizing beam splitter array;
wherein a position of at least one of said first and second lenses is adjustable for calibrating the focusing of said unpolarized light onto said polarizing beam splitter array.

2. The system of claim 1, further comprising:
a light pipe positioned between said light source and said first lens, said light pipe having an input for receiving said unpolarized light from said light source and an output for outputting said unpolarized light towards said first lens.

3. The system of claim 1, further comprising an imager.

4. The system of claim 1, wherein a position of at least one among said first lens and said second lens is fixed.

5. The system of claim 1, wherein said first lens and said second lens are adjustable relative to each other.

6. The system of claim 1, wherein said light source is a lamp comprising an element and a reflector.

7. A projection display comprising:
a polarizing beam splitter array;
at least a first lens and a second lens cascaded for receiving unpolarized light generated from a light source and focusing said unpolarized light onto said polarizing beam splitter array; and
an imager which receives polarized light from said polarizing beam splitter array;
wherein a position of at least one of said lenses is adjustable for calibrating the focusing of said unpolarized light onto said polarizing beam splitter array.

8. The system of claim 7, further comprising:
a light pipe positioned between said light source and said first lens, said light pipe having an input for receiving said unpolarized light from said light source and an output for outputting said unpolarized light towards said first lens.

9. The system of claim 7, wherein said light source is a lamp comprising an element and a reflector.

10. The system of claim 7, further comprising an imager.

11. The system of claim 7, wherein a position of at least one among said first lens and said second lens is fixed.

12. The system of claim 7, wherein said first lens and said second lens are adjustable relative to each other.

13. The system of claim 7, further comprising at least a third lens and a fourth lens cascaded and positioned for receiving polarized light from said polarizing beam splitter array and focusing said polarized light onto said imager.

14. The system of claim 13, wherein a position of at least one of said third and fourth lenses is adjustable for calibrating a size of a beam of said polarized light onto said imager.

15. A method of calibrating a polarization conversion system that includes a light pipe, a polarizing beam splitter array, and at least two lenses located between the light pipe and the polarizing beam splitter array, comprising:
adjusting the position of at least one of the lenses;
wherein said adjusting step focuses unpolarized light onto the polarizing beam splitter array, thereby reducing reflection of said unpolarized light from the polarizing beam splitter array.

16. The method of claim 15, further comprising the step of adjusting the position at least one of a third lens and a fourth lens to adjust a size of a beam of said polarized light onto an imager, said polarized light being received from said polarizing beam splitter array.
